(19) United States
(12) Patent Application Publication
(10) Pub. No.: US 2013/0144865 A1
(43) Pub. Date: Jun. 6, 2013

(54) MANAGING ELECTRONIC PROCUREMENT TRANSACTIONS USING AN OPTIMIZED SEARCH TOOL

(71) Applicants: Martina Rothley, Schwetzingen (DE); Johann Kemmer, Muehlhausen (DE)

(72) Inventors: Martina Rothley, Schwetzingen (DE); Johann Kemmer, Muehlhausen (DE)

(21) Appl. No.: 13/311,574

(22) Filed: Dec. 6, 2011

(51) Int. Cl. G06F 17/30

(52) U.S. Cl. 707/713; 707/E17.131

(57) ABSTRACT

Various embodiments of systems and methods for retrieving open purchase orders using an optimized search tool are described herein. The method involves rendering a set of search parameters on a graphical UI of a computer. In an aspect, the method further includes receiving data relating to at least a first search parameter of the set of search parameters. Further, the method includes determining that data relating to at least a second search parameter of the set of search parameters is unavailable and determining the data relating to the at least second search parameter based on extrapolating the data relating to the at least first search parameter. In an aspect, the method involves performing a search based on the data relating to the at least first search parameter and the at least second search parameter. Based on the performed search, one or more open purchase orders are retrieved for further processing.

### FIELD

The field relates generally to managing electronic procurement transactions in procurement systems, and more specifically, the field relates to automatically retrieving electronic purchase orders using an optimized search tool.

### BACKGROUND

Effective tracking of inventory and purchase orders can be important to the profitability of an enterprise. For example, carefully tracking and scheduling new purchase orders to ensure on-time procurement of items may increase the profitability of the business. Specifically, it is important for a business to maintain up-to-date information regarding open purchase orders and following-up on suppliers to deliver items on time. However, the amount of information and the number of operations that are handled by procurement personnel that is responsible for a large number of purchase orders can grow to be prohibitively expensive. For example, a warehouse worker may be required to mine through the data to access any particular purchase order for performing operations such as coordinating delivery, managing missed delivery, updating purchase orders based on partial deliveries, posting delivery receipt based on current deliveries and the like.

The process of searching for purchase orders and posting delivery receipts becomes complex when the information required for retrieving the purchase orders is limited or missing. Purchasing products and services from a supplier or provider typically involves sending a purchase order (PO) to the supplier requesting a specific number of items for a specific price, and an expected time of delivery. Typically, the ordered items are delivered by a freight carrier to a procurement site of a purchaser along with a delivery note. In an ideal scenario, the delivery note associated with the delivered items will include, among others, a supplier ID, product ID, no. of items delivered, date of delivery, and a purchase order no. In addition to the delivery note, an advanced shipping notification from the supplier may include reference document numbers, bill of lading, or delivery note. Personnel at the warehouse then manually search for an open purchase order based on the information contained in the delivery note and/or advanced shipping notification and post a delivery receipt for the identified purchase order. However, in several instances, neither the delivery note nor the advanced shipping notification provides all the information required to quickly retrieve the corresponding purchase order for the delivered items. Handling such incomplete delivery notes often leads to labor intensive efforts to manually search and retrieve open POs that fit the specifications provided in the delivery note, especially if there are many similar purchase orders which might be used for posting the goods receipt. The PO retrieval task becomes all the more elaborate and time-consuming if the freight carrier delivers the goods for multiple suppliers or multiple purchase orders in a single delivery and the delivery note refers to multiple POs of one supplier or multiple suppliers and contains partly or completely missing information.

### SUMMARY

Various embodiments of systems and methods for retrieving open purchase orders using an optimized search tool are described herein. In one aspect, a method for retrieving open purchase orders using an optimized search tool in an integrated information management system involves rendering a set of search parameters on a graphical user interface of a computer, in an aspect, one or more sets of criteria relating to a product delivery are configured as predefined bundles of search parameters. A set of search parameters is then rendered in response to a selection of a bundle of search criteria from the predefined bundles of search criteria. The method further includes receiving data relating to at least a first search parameter of the set of search parameters. Further, the method includes determining that data relating to at least a second search parameter of the set of search parameters is unavailable and determining the data relating to the at least second search parameter based on extrapolating the data relating to the at least first search parameter. In yet another aspect, the method involves performing a search based on the data relating to the at least first search parameter and the at least second search parameter. Based on the performed search, one or more open purchase orders are retrieved for further processing.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram of a method for retrieving open purchase orders using an optimized search tool, according to one embodiment.

FIG. 2 illustrates an exemplary process flow for retrieving open purchase orders using the optimized search tool, according to one embodiment.

FIG. 3 illustrates an exemplary search interface of the search tool for retrieving customized open purchase orders, in accordance with an embodiment.

FIG. 4 is a block diagram of an exemplary system for retrieving open purchase orders using the optimized search tool, according to one embodiment.

FIG. 5 is a block diagram of an exemplary computer system according to one embodiment.

### DETAILED DESCRIPTION

Embodiments of techniques for retrieving open purchase orders using an optimized search tool are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. in other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

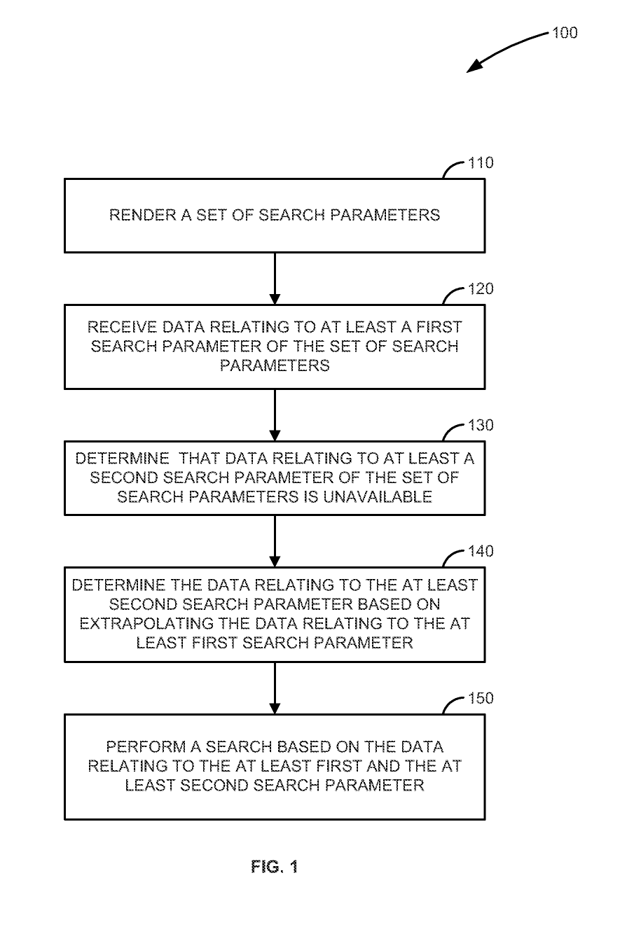

FIG. 1 illustrates a flow diagram of a method 100 for retrieving open purchase orders using an optimized search toot, according to an embodiment. The method 100, implemented by a computer in an integrated information management system, includes configuring a set of search criteria as search parameters for searching and retrieving open purchase orders. The set of search criteria refer to information relating to product delivery, such as purchase order no., supplier product ID, product type, product category, item description, no. of items delivered, organizational unit, procurement type, delivery date, freight carrier, etc. Invoking the search tool renders a search interface on a graphical user interface of the computer. The search interface provides one or more search parameters and associated fields for entering data. In an aspect, different combinations of search criteria may be combined together to form pre-defined bundles of search parameters. The pre-defined bundles of search parameters may be provided as user selectable options on the search interface, such that a suitable combination of search parameters can be selected by selecting a bundle. For example, particular bundle of search parameters of the predefined bundles can be selected depending on the product delivery data that is available for the combination of search criteria in that particular bundle. In response to receiving a selection of a bundle of search criteria from the predefined bundles of search criteria, a corresponding set of search parameters is rendered (110) on the user interface of the search tool. Alternatively, the set of search parameters may be configured as default settings in the system during initial setup of the search tool.

As used herein, the term “purchase order” refers to a commercial document issued by a purchaser to a supplier, indicating product type, quantity, and agreed prices for products or services that the supplier will provide to the purchaser. The term “open purchase order” refers to a purchase order that is not fulfilled, i.e., the purchase order for which the ordered products are yet to be delivered by the supplier. The terms “commodity,” “goods,” and “product” will hereinafter be used interchangeably and refer to one and the same. Examples of commodity include, but are not limited to, finished products, raw materials, parts, spares, components, and computer readable storage mediums. The term “supplier” as used herein refers to a dealer, a manufacturer, a business partner, a contractor, a seller dealing with the sourcing product and the like. The term “purchaser” as used herein refers to an entity buying or procuring an item by way of a purchase order.

Referring back to FIG. 1, the method 100 further includes receiving (120) data in the field corresponding to at least a first search parameter provided in the search interface. The data relating to the search parameters may be extracted from a delivery note by examination of the delivery note at a procurement site by personnel, machine vision systems, automaton, IR reader, or any other scanning system. In an example, the delivery note is a physical document provided by a freight carrier at the time of delivering the ordered items at a procurement site of a purchaser. In another example, the delivery note is a stamping on a casing of the delivered items. In yet another example, the delivery note is a delivery notification received via e-mail or as a short message service on a communication device associated with the procurement system. Subsequent to detecting that data relating to the at least a first search parameter is received in the associated field in the search interface, the method 100 includes determining (130) whether data relating to at least a second search parameter is received. In an example, the data relating to the at least first search parameter is manually entered in the associated fields in the search interface. In another example, the data relating to the at least first search parameter is automatically rendered by a scanning system that is used to extract product delivery from a delivery note. If it is determined that the data relating to the second search parameter is not received in the associated field, the method 100 includes extrapolating the received data relating to the at least first search parameter in order to determine (140) the data relating to the at least second search parameter that is unavailable. If it is detected that the data relating to the entire set of search parameter is received, the method proceeds to perform (150) a search based on the data received for the first and second search parameters. In an embodiment, the search is performed consequent to detecting that a predetermined number of search parameters are available, including those received directly in the search parameter fields and those derived by extrapolation. In another embodiment, the search is performed in response to receiving a search command through one of: selection of a “search” option provided in the search interface, activation of a dedicated button on an input interface, or a voice input. Based on the performed search, one or more open purchase orders are retrieved for further processing.

Extrapolating the received data relating to the at least one search parameter in order to derive the data relating to the one or more other unavailable search parameter includes estimating unknown values based on projecting or extending the statistics pertaining to known values. For example, for a set of five search parameters that is rendered on the search interface of the search tool, a product delivery note may have the product delivery data for only two of the five search parameters. The product delivery data for the two search parameter are then rendered in the fields associated with each of the two search parameters. The remaining three of the five search parameters do not receive a value in their associated fields. In order to derive a value for at least one of the three search parameters, an extrapolation analysis is performed on statistical data relating to the two search parameters. Statistical data refers to historical data relating to past product delivery information associated with the data received for the two search parameters. Based on extrapolating the statistical data, the values relating to at least one of the three search parameters may be derived. The derived values are then rendered in the associated fields of the three search parameters. A search may then be performed using one or more of the three search parameters having the derived values and the two search parameters having received values to retrieve open Purchase Orders matching the specifications defined by the search parameters. A Purchase Order search performed using more number of search parameters yields more relevant results.

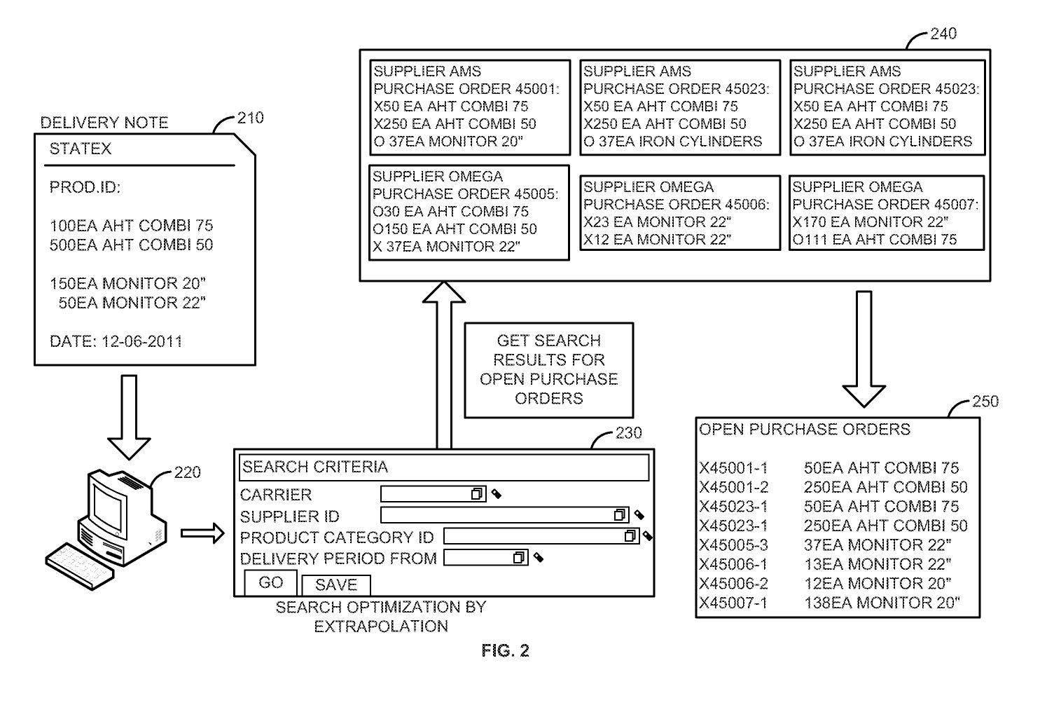

In an example scenario as shown with reference to FIG. 2, upon receiving a delivery note 210 associated with a product delivery from a freight carrier, a search tool is invoked on a user interface of a computer 220. The computer may be a part of a procurement system or the ERP backend system. The invoked search tool renders a search interface 230 providing a set of search parameters and associated fields for entering a respective value. In the given example, the set of parameters include Freight Carrier, Supplier ID, Product ID, and delivery period. However, the delivery note only contains product delivery data relating to product category ID, product ID, and the product delivery date. The product delivery data relating to Supplier ID is not provided in the delivery note. The product delivery data that is available from the delivery note is entered in the associated fields in the search interface. Performing a search at this stage with only three of the four search parameters might yield broad results which may have to undergo further scrutiny. In order to perform an optimized search that produces relevant search results, the data relating to the search parameter Supplier ID is derived using the data related to Product ID, Freight Carrier, Delivery date, or any combination. In an embodiment, the search optimization process may be automatically initiated based on the search tool detecting that the data relating to the Supplier ID is not received in the associated field. For example, the search tool detects that the data associated with the Supplier ID is not received for a pre-determined amount of time and initiates the search optimization process.

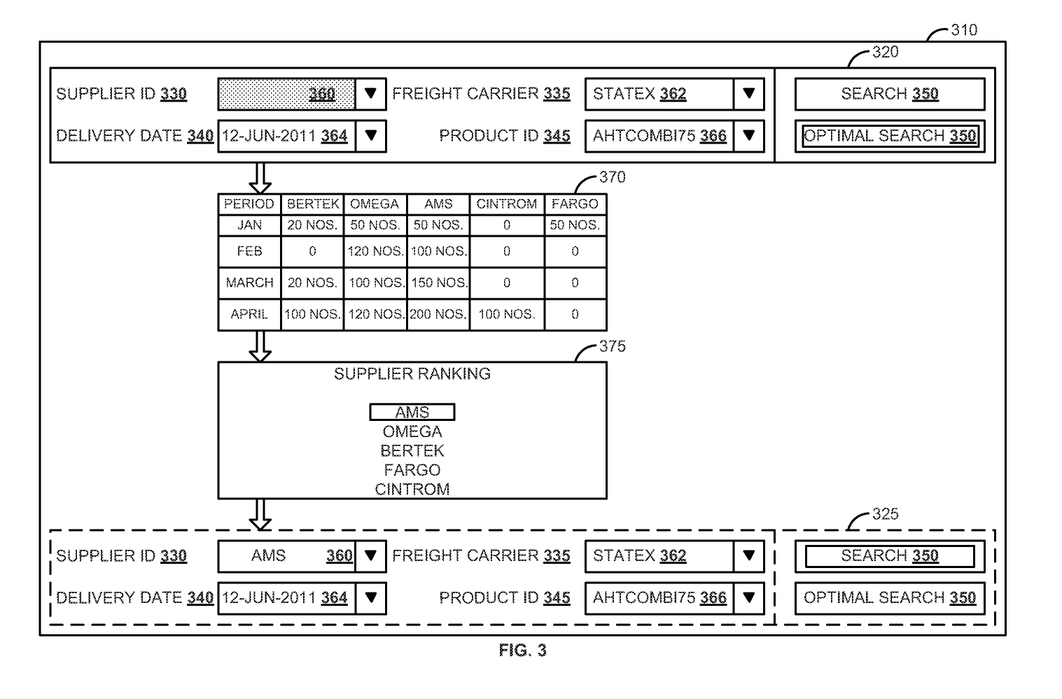

In another embodiment, the search optimization process may be initiated based on the search tool receiving a prompt to initiate the search optimization process. For example the search tool may receive a prompt from a user through the selection of an “Optimize Search” option provided on the search interface. In yet another embodiment, the search optimization process may be automatically initiated upon receiving a command to perform a search for POs. In this respect, the search tool upon receiving the command to perform a search for POs detects that the data relating to Supplier ID has not been received and automatically initiates the search optimization process. Once the search optimization process is initiated through any of the above mentioned embodiments, the search tool identifies the search parameters for which product delivery data is unavailable. In the given example, the search tool identifies Supplier ID as the search parameter for which product delivery data is unavailable. The search tool then performs extrapolation analysis on the data relating to at least one of Product ID, Freight carrier, and Delivery data to derive a likely value for Supplier ID. Based on the value derived for Supplier ID and the data relating to Product ID, Freight carrier, and Delivery date, the search tool searches a database 240 of purchase orders and retrieves a list 250 open purchase orders relating to the specifications provided by the search parameters. The retrieved open purchase orders may be further processed by posting a delivery receipt for the purchase orders and modifying the status of the purchase orders as closed. In the case of partial delivery, if only a subset of the ordered items in a purchase order is delivered, the purchase orders remain open and the delivery receipt may be posted for only the delivered number of items. The search optimization process will be explained in more detail with reference to FIG. 3.

FIG. 3 illustrates a search interface 310 of the search tool for retrieving customized open purchase orders, in accordance with an embodiment. The search interface 310 includes a search panel 320 providing a set of search parameters (330, 335, 340, and 345), a “search” tab 350 for performing a search, and an “optimize search” tab 355 for optimizing a search. The set of search parameters includes Supplier ID 330, Freight Carrier 335, Delivery date 340, and Product ID 345. Further, the search panel 320 includes fields (360, 362, 364, and 366) associated with each of the search parameters (330, 335, 340, and 345) for receiving data relating to the search parameters (330, 335, 340, and 345). The fields (362, 364, and 366) associated with the search parameters Freight Carrier 335, Delivery Date 340, and Product ID 345 are populated with data, white the field 360 associated with the search parameter Supplier ID 330 remains blank for unavailability of Supplier ID information. In the given example, the product delivery data StatEx, 12 Dec. 2014, and AHT Combi 75 relating to Freight Carrier 335, Delivery Date 340, and Product ID 345 respectively are extracted from a product delivery note or an advanced shipping notification associated with a particular product delivery. However, the product delivery data relating to Supplier ID 330 is unavailable due to an incomplete product delivery note. A search optimization process may be initiated in the search tool, by selecting the “Optimize Search” tab 355 provided in the search panel 320, in order to derive a value for Supplier ID 330. In another aspect, the search optimization process may be automatically initiated by the search tool in response to a selection of the “search” tab 350 and subsequently detecting that at least one of the set of search parameters is not available. Upon initiation of the search optimization process, the search tool retrieves statistical data relating to at least one of Product ID, Freight Carrier, and Delivery date.

For example, the search tool may retrieve statistical data relating to the Freight Carrier in order to generate a proposal of one or more suppliers that are likely to be associated with this particular product delivery for which delivery receipt is to be posted. The statistical data refers to data collected over a certain period of time and stored in persistent storage associated with the integrated system. In the given example, the search tool may retrieve statistical data relating to StatEx's past product deliveries for product: AHT Combi 75 by one or more suppliers. The statistical data may be rendered on the search interface as shown in table 370. As shown in table 370, the statistical data includes a listing of a set of suppliers who have partnered with StatEx in delivering AHT Combi 75 during the period between January and April. The table 370 also includes information regarding the number of items delivered by each supplier during a certain period of time. This statistical data may be extrapolated to determine the supplier(s) who is most likely to be associated with this particular delivery. For example, based on the statistical data, a ranked list 375 of suppliers partnering with StatEx may be determined. The supplier ranking may be determined based on, for example, the total number of items delivered during a block of time. In another example, the supplier ranking may be determined based on the frequency of product deliveries undertaken by StatEx for a particular supplier. In yet another example, the supplier ranking may be determined based on the most recent product delivery activity by each of the suppliers. One of ordinary skill in the art will understand that other similar criteria can be used based at least on the parameter in question.

In the given example, the supplier relating to Supplier ID: “AMS” tops the ranked list 375 of suppliers. The supplier “AMS” may then be automatically rendered in the field 360 associated with Supplier ID 330 on the search panel 320 based on a predefined setting. Subsequently, the data in the fields 360, 362, 364, and 366 namely AMS, StatEx, 12 Jun. 2011, and AHT Combi75 are used for performing a search for open purchase orders. Alternatively, any of the list of suppliers “AMS,” “OMEGO,” “BERTEK,” “FARGO,” and “CINTRON” can be iteratively selected and a search be performed until a fitting open purchase order is found.

Similarly, in a scenario in which the data relating to only the Supplier ID and Delivery date is available from the delivery note, the data relating to Freight Carrier and the product ID may be derived based on extrapolating the data relating to Supplier ID and Delivery date. For example, the statistical information regarding the products supplied by supplier “OMEGO” in the past may be used to derive one or more products that are likely to have been delivered by this particular delivery by OMEGO. Other additional statistical information such as the frequency of delivering a certain product by OMEGO may aid in arriving at a product that is likely to be delivered on the current delivery date. Once the data relating to Product ID is determined, the search tool may further derive the Freight carrier information based on the Supplier ID, Delivery date and the now derived product ID. For example, the statistical data regarding the Freight Carriers partnering with OMEGO in delivering a product having Product ID: Monitor 20″ in the past deliveries may be extrapolated to arrive at a Freight Carrier that is likely to have delivered the current delivery. Having realized the values for Product ID and Freight Carrier, the search tool performs an optimized search using the search parameters Supplier ID, Freight Carrier, Product ID, and Delivery date to retrieve the fitting open purchase order(s).

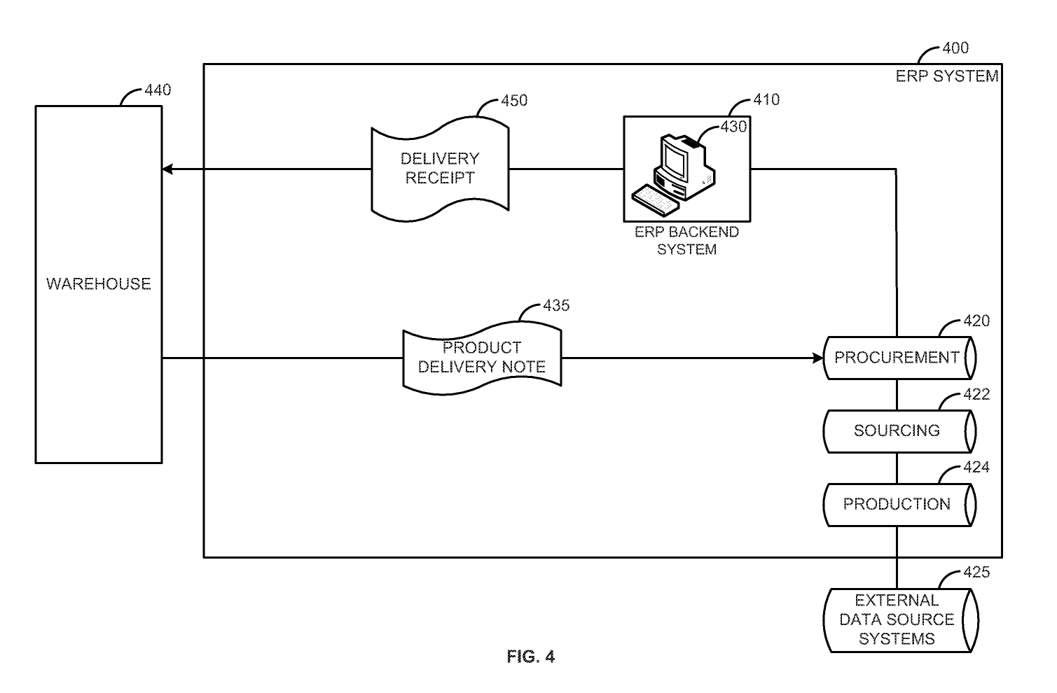

FIG. 4 is a block diagram of an exemplary system for retrieving open purchase orders using the optimized search tool, according to one embodiment. The system 400 includes a backend system 410, one or more business systems 420, 422, and 424, and external data source systems 425. In an embodiment, the system 400 is an ERP system integrated over a communication network. The ERP system 400 includes business systems relating to procurement 420, sourcing 422, and production 424, integrated to each other over a communication network. Further, the ERP system 400 is enabled with automated pull mechanisms allowing real-time processing and execution of inspection data. As used herein, the term “real-time” refers to a time frame that is brief, appearing to be immediate or near concurrent. When a computer processes data in real-time, it reads and handles data as it is received, producing results without delay. The ERP backend system 410 may include a computer 430 operating in communication with the business systems 420, 422, and 424, and external data source systems 425. Data source systems 425 include sources of data that enable data storage and retrieval. For example, data source systems 425 may include databases, such as, relational, transactional, hierarchical, multi-dimensional (e.g., OLAP), object oriented databases, and the like. Data source systems 425 may also include a data source where the data is not tangibly stored or otherwise ephemeral such as data streams, broadcast data, and the like.

The computer 430 includes a processor (not shown) that executes software instructions or code comprising the optimized search tool, stored on a computer readable storage medium, to perform the above-illustrated methods. The computer 430 includes a media reader to read the instructions from the computer readable storage medium and store the instructions in storage or in random access memory (RAM). For example, the computer readable storage medium includes executable instructions for performing operations including, but not limited to, rendering a set of search parameters as search parameters, receiving data relating to at least one search parameter of the set of search parameters, detecting that data relating to at least one other search parameter of the set of search parameters is unavailable, determining the data relating to the at least one other search parameter based on extrapolating the data relating to the at least one search parameter, and performing a search based on the data relating to the at least one search parameter and the at least one other search parameter. The business systems relating to procurement 420, sourcing 422, and production 424, among others, may each include a computer (not shown) operating on a set of instructions to perform associated functions. The user interface of the computer 430 is configured to display a search interface (See FIG. 3) of the search tool, which includes a set of search parameters used to perform a Purchase Order search.

According to an aspect, the computer 430's memory holds a set of search parameters relating to a product delivery that are designated as search parameters and one or more pre-defined bundles comprising one or more search criteria. The pre-defined bundles may be provided as user selectable options on the search interface such that upon selecting one of the bundles, the corresponding search parameters are rendered on the search interface. In an example, the set of search criteria refer to information relating to product delivery, such as purchase order no., supplier ID, product ID, product type, product category, item description, no. of items delivered, organizational unit, procurement type, delivery date, freight carrier, etc. Example of the pre-defined bundles of search criteria for a purchase order system include:
By Supplier, Delivery Date, Product
By Supplier, Delivery Date, Product Category
By Supplier, Delivery Date
By Freight Forwarder, Delivery Date, Product
By Freight Forwarder, Delivery Date, Product Category
By Freight Forwarder, Supplier, Delivery Date, Product ID
By Freight Forwarder, Delivery Date
By Freight Forwarder, Supplier, Delivery Date, Product Category
By Freight Forwarder, Supplier, Delivery Date

The product delivery data relating to the set of search parameters may be extracted from a product delivery note 435 procured by the procurement system 420 from a warehouse 440. For example, the product delivery note may be provided by a Freight Carrier at the time of delivery of the ordered items at the warehouse 440. The procurement system 420 may extract the product delivery data from the product delivery note by using a scanning means and store the extracted product delivery data in temporary or persistent storage within the procurement system 420 or the backend system 410. Alternatively, personnel at the warehouse may extract the product delivery data from the product delivery note by manually examining the product delivery note and recording the product delivery data in the procurement system 420 or backend system 410. The processor of the computer in either the procurement system 420 or the backend system 410 may automatically invoke the search tool in response to receiving the product delivery data. In another aspect, the search toot may be invoked by the processor in response to receiving instructions to invoke the search tool. The processor then displays a search interface of the search tool on a graphical user interface of the computer.

The processor then renders a user selected set of search parameters or a pre-defined set of search parameters on the search interface and populates the fields associated with the set of search parameters with the received product delivery data. The processor, upon sensing that the product delivery data relating to at least one search parameter is not received within a predetermined period of time, initiates a search optimization process. The data relating to the at least one search parameter may not be available due to an incomplete delivery note. Alternatively, the processor initiates the search optimization process upon receiving an instruction to perform a search for retrieving POs. In the latter case, subsequent to receiving the instruction to perform a search for retrieving POs the processor detects that data relating to at least one of the set of search parameters is unavailable and automatically initiates the search optimization process. In another aspect, the processor initiates the search optimization process in response to receiving an instruction to perform the search optimization process. For example, the instruction may be provided through the activation of a key provided on an input interface such as a key board or through the selection of a tab provided on the search interface by means of a touch input, voice command, or pointer selection. The processor initiates the search optimization by retrieving statistical data associated with the received product delivery data in order to estimate the data that is unavailable for the at least one search parameter. The statistical data as used herein refers to archived data relating to the past deliveries. For example, the statistical data may pertain to the received data relating to at least one of the search parameters involving Supplier ID, product ID, delivery date, Purchase Order no. Freight Carrier, etc. The processor may retrieve the statistical data from the memory and/or from external data source systems where the archived data may be stored in databases. The processor then extrapolates the retrieved statistical data to estimate the unavailable data relating to the at least one search parameter. The processor may follow any of the extrapolation methods including but not limited to linear extrapolation, polynomial extrapolation, conic extrapolation, French curve extrapolation, etc. The term “extrapolation” as used herein is defined as the process of estimating a value of a variable outside a known range from values within a known range by assuming that the estimated value follows logically from the known values.

In an example, the processor may invoke the search tool and render a set of search parameters in response to a selection of a bundle of search criteria involving Supplier ID, Product Category, No. of items delivered, Freight Carrier, and Delivery date. The processor may receive the Delivery date information as 12 Jul. 2011, a No. of items delivered as 300 items, and the Product category information as AHT Combi 70, through an input interface of the computer or from a scanning device coupled to the computer. The processor renders the date information, no, of items delivered, and the Product category information in the associated fields in the search interface of the search toot. The processor then detects that Freight Carrier information and Supplier ID information is not received within a certain period of time and initiates the search optimization process. The certain period of time may be defined by a predetermined time limit in minutes/seconds. Alternatively, the certain period of time may be defined by the receiving of an instruction to perform a search optimization process. The processor then retrieves statistical data relating to the Product category information with the Delivery data as a limiting factor. For example, the processor may retrieve archived information relating to the past deliveries for the given Product category, where the past deliveries may be limited to the deliveries within the last six months prior to the given Delivery date. Referring to the example provided in Table 1 below, the archived information relating to the product deliveries in the last six months prior to 12 Jun. 2011 for AHT Combi 70 may be retrieved.

TABLE 1

| | | Month | | | | | |
|---|---|---|---|---|---|---|---|
| Supplier | Carrier | June | May | April | March | February | January |
| AMS | Portline | 100 items | 500 items | 0 items | 150 items | 150 items | 150 items |
| OMEGO | FastFly | 50 items | 100 items | 0 items | 0 items | 50 items | 50 items |
| BERTEK | StatEx | 150 items | 0 items | 50 items | 100 items | 200 items | 150 items |
| FARGO | FastFly | 100 items | 90 items | 50 items | 100 items | 100 items | 100 items |
| CINTRON | RapidEx | 300 items | 200 items | 50 items | 100 items | 150 items | 200 items |

The processor then performs an extrapolation on the retrieved statistical data to determine the supplier(s) which is likely to be associated with the current delivery. The extrapolation analysis extends the statistical data (in Table 1) relating to deliveries in the last six months, to assess the likelihood of at least one of the suppliers involved in the past deliveries for product AHT Combi 70 to deliver 300 items of AHT Combi 70 on 12 Jul. 2011. Based on the statistical information shown in the example in Table 1, the extrapolation analysis may list INTRON as one of the probable suppliers associated with the delivery of 300 items of AHT Combi 70 on 12 Jul. 2011. The processor then renders the derived data relating to the Supplier ID in the associated field on the search interface. The processor may then automatically proceed to perform a search to retrieve the Purchase orders that indicate an order for 300 nos. of AHT Combi 70 from CINTRON to be delivered on 12 Jul. 2011. Alternatively, the processor may perform the search for Purchase Orders in response to receiving an instruction to perform a search. The processor then retrieves one or more fitting open Purchase Orders based on the search and posts a delivery receipt 450 for the one or more purchase orders.

The extrapolation analysis may be iteratively performed until the data relating to the entire set of search parameters is derived. Alternatively, extrapolation analysis may be iteratively performed until the data relating to a predetermined number of search parameters is derived. Further, in an embodiment, different weights may be assigned to the various search parameters, such that, the processor may perform the extrapolation analysis for deriving the unknown search data for the search parameters, in a sequence dictated by the weights assigned to the various search parameters. For example, the search parameters Supplier ID, Product ID, and Freight Carrier may be assigned a higher weight than No. of Items, Procurement Type, or Product category. Based on the assigned weights, the processor may derive the values for Supplier ID, Product ID, or Freight Carrier at a higher priority that Procurement type, No. of items, or Product category. In another embodiment, the order of deriving the missing data for a set of search parameters may be predefined, such that the processor upon identifying the search parameters, for which data is unavailable, performs extrapolation analysis for deriving the missing data in the predefined order.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

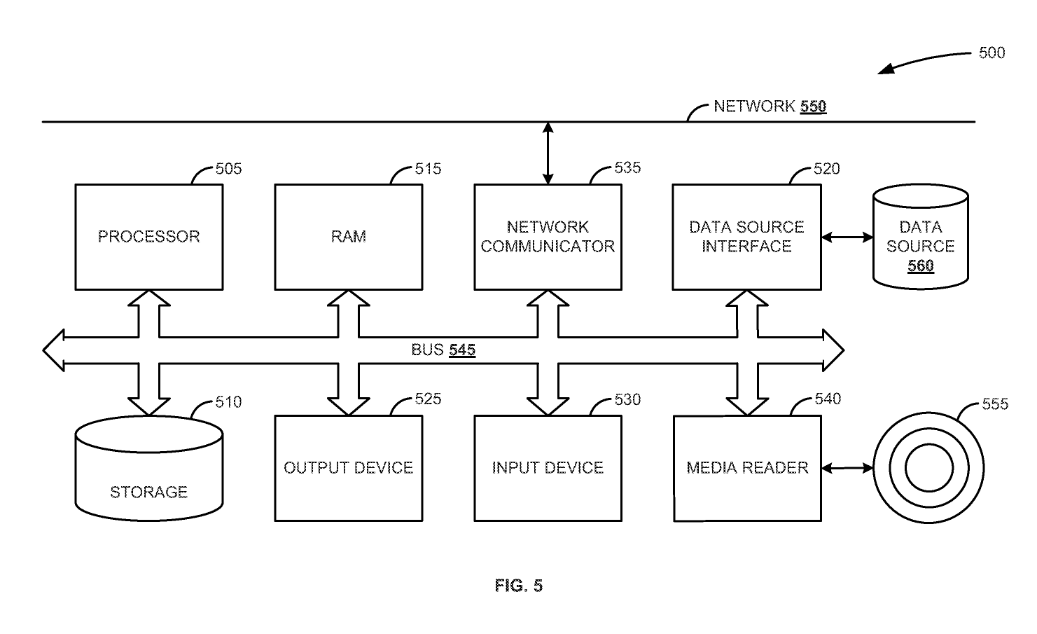

FIG. 5 is a block diagram of an exemplary computer system 500. The computer system 500 includes a processor 505 that executes software instructions or code stored on a computer readable storage medium 555 to perform the above-illustrated methods of the invention. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment of the invention, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource, Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method comprising:
rendering a set of search parameters on a computer generated user interface (UI);
receiving data relating to at least a first search parameter of the set of search parameters;
determining, by the computer, that data relating to at least a second search parameter of the set of search parameters is unavailable;
determining, by the computer, the data relating to the at least second search parameter based on extrapolating the data relating to the at least one search parameter; and
performing a search based on the data relating to the at least first search parameter and the at least second search parameter.

2. The method of claim 1, wherein rendering the set of search parameters comprises rendering the set of search parameters in response to receiving a selection of a bundle of search criteria from one or more predefined bundles of search criteria.

3. The method of claim 1, wherein detecting that data relating to the at least second search parameter of the set of search parameters is unavailable comprises detecting that the data relating to the at least second search parameter is not received within a determined period of time.

4. The method of claim 3, wherein detecting that the data relating to the at least one other search parameter is not received within a determined period of time comprises receiving an instruction to perform an optimized search.

5. The method of claim 1, wherein determining the data relating to the at least second search parameter based on extrapolating the data relating to the at least first search parameter comprises:
predicting a set of values relating to the at least second search parameter based on extrapolating the data relating to the at least first search parameter; and
receiving a selection of at least one value from the predicted set of values as the data relating to the at least second search parameter.

6. The method of claim 5, wherein predicting the set of values relating to the at least second search parameter comprises predicting a set of supplier IDs of a particular product based on extrapolating a history of transactional data relating to product delivery by a particular carrier.

7. The method of claim 1, wherein performing the search based on the data relating to the at least first search parameter and the at least second search parameter comprises searching for one or more open purchase orders based on the data relating to the at least first search parameter and the at least second search parameter.

8. The method of claim 7 further comprising modifying a status of at least one of the one or more open purchase orders based on product delivery data of a product delivery note.

9. The method of claim 1, wherein receiving data relating to the at least first search parameter of the set of search parameters comprises extracting data relating to the at least first search parameter from a product delivery note.

10. An article of manufacture, comprising:
a computer readable storage medium having instructions which when executed by a computer causes the computer to:
render a set of search parameters on a computer generated user interface (UI);
receive data relating to at least a first search parameter of the set of search parameters;
determine that data relating to at least a second search parameter of the set of search parameters is unavailable;
determine the data relating to the at least second search parameter based on extrapolating the data relating to the at least first search parameter; and
perform a search based on the data relating to the at least first search parameter and the at least second search parameter.

11. The article of manufacture in claim 10, wherein determining the data relating to the at least second search parameter based on extrapolating the data relating to the at least first search parameter comprises:
predicting a set of values relating to the at least second search parameter based on extrapolating the data relating to the at least first search parameter; and
selecting at least one value from the predicted set of values as the data relating to the at least second search parameter.

12. The article of manufacture in claim 10, further comprises instructions to rank the predicted set of values based on a determined search parameter.

13. The article of manufacture in claim 10, further comprises instructions to configure one or more search parameter as pre-determined bundles of search parameters.

14. An integrated system operating in a communication network, comprising:
at least one data source system;
a data repository to store data collected from the at least one data source system; and
a computer comprising a memory to store a program code, and a processor to execute the program code to:
render a set of search parameters on a computer generated user interface (UI);
receive data relating to at least a first search parameter of the set of search parameters;
determine that data relating to at least a second search parameter of the set of search parameters is unavailable;
determine the data relating to the at least second search parameter based on extrapolating the data relating to the at least first search parameter; and
perform a search based on the data relating to the at least first search parameter and the at least second search parameter.

15. The system of claim 14, wherein the set of search parameters relates to product delivery data.

16. The system of claim 14, wherein the set of search parameters is rendered on a user interface associated with the computer.

17. The system of claim 16, wherein the set of search parameters is rendered on the user interface in response to receiving, on the user interface associated with the computer, a selection of a bundle of search parameters from one or more predefined bundles of search parameters.

18. The system of claim 14, wherein the product delivery data includes at least one of: supplier, freight forwarder, delivery date, product ID, product type, product category, no. of delivered items, item description, organizational unit, and procurement type.

19. The system of claim 14, wherein the product includes at least one of a service, a solution, and an article of manufacture.

20. The system of claim 14, wherein the at least one data source system includes at least one of a web service, a data warehouse, an integrated ERP system, and external feed from suppliers.
